(19) United States
(12) Patent Application Publication
(10) Pub. No.: US 2013/0308889 A1
(43) Pub. Date: Nov. 21, 2013

(54) CYLINDRICAL ROLLER BEARING APPARATUS

(71) Applicant: Carlos Alfredo Vallejo Gordon, Erie, PA (US)

(72) Inventor: Carlos Alfredo Vallejo Gordon, Erie, PA (US)

(21) Appl. No.: 13/983,792

(22) PCT Filed: Feb. 8, 2012
(86) PCT No.: PCT/US12/24316

§ 371 Date: Aug. 6, 2013

Related U.S. Application Data
(60) Provisional application No. 61/440,557, filed on Feb. 8, 2011.

(51) Int. Cl. B60B 27/00

(52) U.S. Cl. CPC B60B 27/001
USPC 384/569; 301/6.5

(57) ABSTRACT

A cylindrical roller bearing includes an annular outer race, an annular inner race, a plurality of rollers captured between the inner race and the outer race and a cage operatively connecting together the plurality of rollers for rotating and revolving motion of the rollers between the inner and the outer races. The inner race has an enlarged inner diameter and a reduced thickness relative to the radial loads to be supported.

### FIELD OF THE INVENTION

Embodiments of the invention relate to wheel drive assemblies of off-highway vehicles, and, more particularly, to cylindrical roller bearings for use in such wheel drive assemblies.

### BACKGROUND OF THE INVENTION

Off-highway vehicles (“OHVs”), such as mining vehicles used to haul heavy payloads excavated from open pit mines, usually employ motorized wheels for propelling or retarding the vehicle in an energy efficient manner. In particular, OHVs typically use a large horsepower diesel engine in conjunction with an alternator, a main traction inverter, and a pair of wheel drive assemblies housed within the rear tires of the vehicle. The diesel engine is directly associated with the alternator such that the engine drives the alternator. The alternator, in turn, powers the main traction inverter, which supplies electrical power having a controlled voltage and frequency to electric drive motors of the two wheel drive assemblies. Each wheel drive assembly houses a planetary gear transmission that converts the rotation of the associated drive motor energy into a high torque low speed rotational energy output which is supplied to the rear wheels.

As the weight of an OHV presents challenges for operation and maintenance of such vehicles, reducing overall vehicle weight is highly desired. As such, it is generally desirable to provide wheel assembly components, e.g., roller bearings, that are as light as practicable.

### BRIEF DESCRIPTION OF THE INVENTION

In one embodiment, a cylindrical roller bearing includes an annular outer race, an annular inner race, a plurality of rollers captured between the inner race and the outer race and a cage operatively connecting together the plurality of rollers for rotating and revolving motion of the rollers between the inner and the outer races. The inner race has an enlarged inner diameter and a reduced thickness relative to the radial loads to be supported.

In another embodiment, a wheel assembly for an off-highway vehicle includes a wheel frame, a torque tube having a ring gear, a wheel hub secured to the torque tube and supported on the wheel frame and, within the wheel frame, a sun gear shaft splined to a shaft of an electric motor, the sun gear shaft having a sun gear that is meshed with a plurality of planet gears carried on a planet gear shaft, the planet gear shaft having a pinion engaged with the ring gear of the torque tube and being supported in the wheel frame by a plurality of thrust bearings and at least one cylindrical roller bearing. The at least one cylindrical roller bearing has an annular outer race, an annular inner race having a reduced thickness as compared to the outer race and an enlarged inner diameter so as to permit assembly over the pinion of the planet gear shaft, a plurality of rollers captured between the outer race and the inner race and a cage operatively connecting together the plurality of rollers.

In another embodiment, a cylindrical roller bearing for supporting radial loads within a wheel drive assembly of an off-highway vehicle includes an annular outer race, an annular inner race, a plurality of rollers captured between the inner race and the outer race, and a cage operatively connecting together the plurality of rollers for rotating and revolving motion of the rollers between the inner and the outer races. The inner race has an inner diameter of approximately 228 millimeters and a thickness of approximately 11 millimeters, and the roller bearing has a dynamic load rating of approximately 217,000 pounds (98,636 kg).

### BRIEF DESCRIPTION OF THE DRAWINGS

The present invention will be better understood from reading the following description of non-limiting embodiments, with reference to the attached drawings, wherein below:

FIG. 1 shows a perspective view of an OHV.

FIG. 2 shows a partial perspective cutaway view showing a wheel drive assembly of the OHV shown in FIG. 1.

FIG. 3 shows a perspective view of the wheel drive assembly shown in FIG. 2, for use with a cylindrical roller bearing in accordance with an embodiment of the present invention.

FIG. 4 shows a side sectional view of the wheel drive assembly shown in FIG. 2, including a cylindrical roller bearing in accordance with an embodiment of the present invention.

FIG. 5 shows a detail view from FIG. 4 including the cylindrical roller bearing.

FIG. 6 shows a perspective view of the cylindrical roller bearing shown in FIGS. 4-5, according to an embodiment of the present invention.

FIG. 7 shows a side sectional detail view of the cylindrical roller bearing shown in FIGS. 4-6.

FIG. 8 shows a perspective view of a wheel frame of the wheel drive assembly shown in FIG. 4.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts.

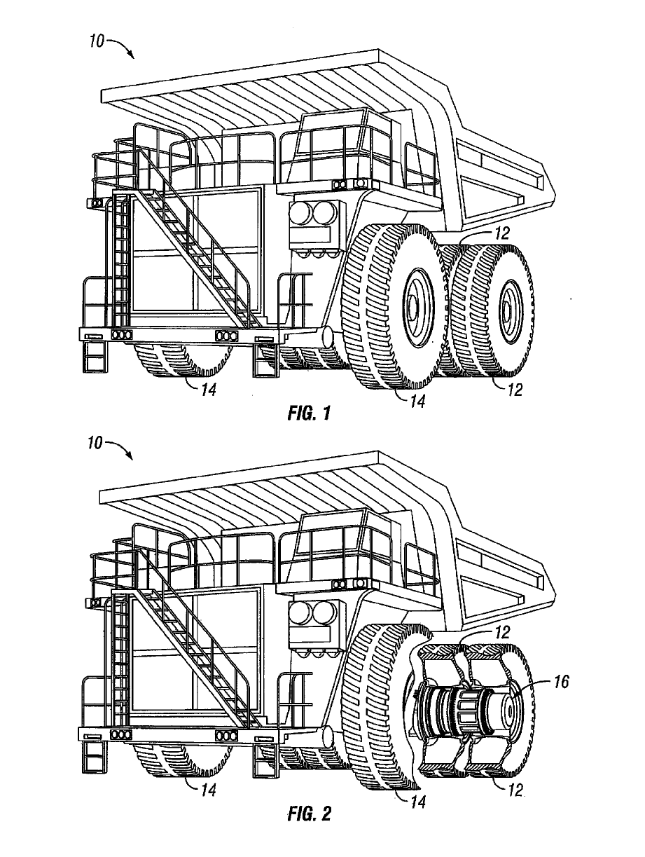

An embodiment of the inventive bearing is configured for use with a wheel assembly 16 of an OHV 10 as depicted in FIGS. 1 and 2. As shown, the OHV 10 is supported on paired dual rear drive tire assemblies 12 and on single front steering tire assemblies 14. Each pair of rear drive tire assemblies 12 are mounted on a wheel assembly 16. Such an OHV may be massive in scale. For example, the OHV 10 may weigh in excess of two hundred sixty (260) tons, empty.

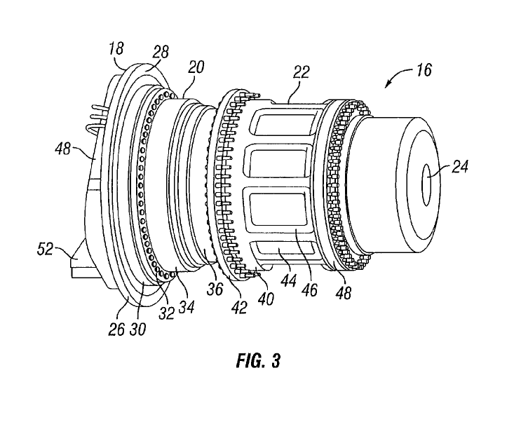

Referring to FIG. 3, each wheel assembly 16 includes a wheel frame 18, a torque tube 20, and a wheel hub 22 that is fastened to the torque tube and supported on the wheel frame. In embodiments, the torque tube is bolted to the wheel hub 22, to which the tire assemblies 12 can be bolted as further discussed herein. Axially adjacent to the wheel hub 22, a brake assembly 24 also is mounted on the wheel frame 18 but is not fastened to the wheel hub. Axially opposite the brake assembly 24, a gear cover 48 is mounted onto the wheel frame 18.

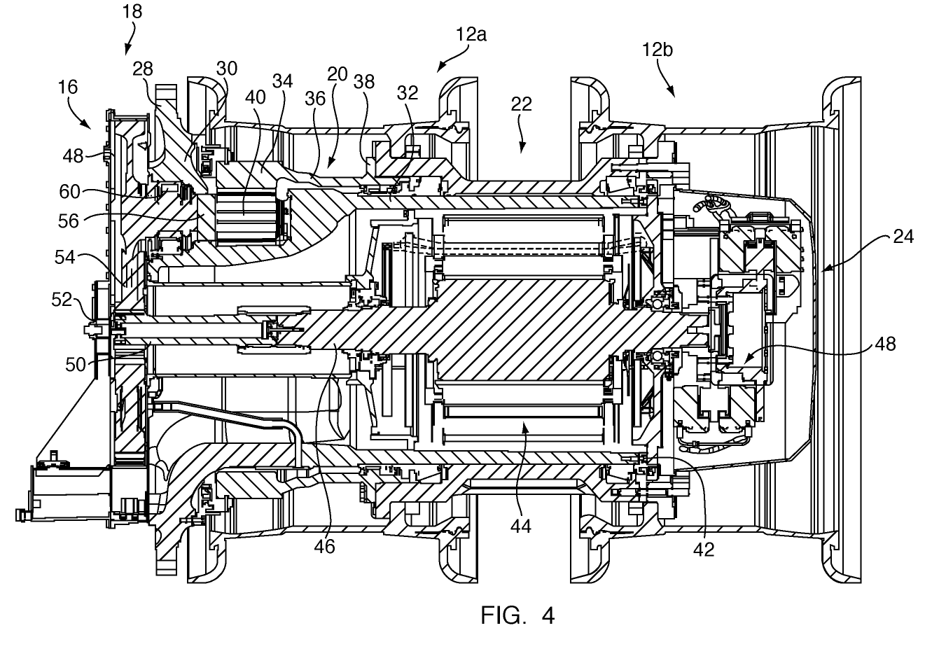

Each wheel assembly 16 can be bolted to the vehicle 10 by way of a mounting flange 28 provided on the wheel frame 18. The wheel frame 18 is radially tapered from the mounting flange 28, through a generally conical or hyperbolic transition portion 30, to a main cylindrical or substantially cylindrical barrel portion 32 (shown in FIG. 4). The torque tube 20 includes a ring gear 34 adjacent to the mounting flange 28 of the wheel frame 18, and also includes a tube barrel 36 that extends from the ring gear 34 along the wheel frame to a wheel hub flange 38.

Referring to FIG. 4, the ring gear 34 is engaged with planet pinion gears 40 that are housed in, and protrude through, the wheel frame 18. The wheel hub flange 38 is an integral part of the wheel hub 22. The torque tube 20 is supported around the barrel portion 32 of the wheel frame 18 by its attachment to the wheel hub 22 and by its engagement with the planet pinion gears 40.

As shown in FIG. 4, inboard and outboard tire assemblies 12a, 12b can be bolted onto the wheel hub 22. Within the wheel hub 22, the barrel portion 32 of the wheel frame 18 extends from the transition portion 30 to an annular hub end surface 42, to which the brake assembly 24 is mounted. Adjacent the hub end surface 42, an electric traction motor 44 is housed inside the wheel frame 18. From the electric motor 44 a shaft 46 protrudes centrally along the wheel frame 18 toward a first end proximate to the mounting flange 28, and toward a second end within the brake assembly 24. Within the brake assembly 24, a brake rotor 48 is mounted onto the second end of the shaft 46. Within the transition portion 30 of the wheel frame 18, a sun gear shaft 50 is splined to the first end of the shaft 46. The end of the sun gear shaft 50 disposed proximate the gear cover 26 is formed as a sun gear 52. The sun gear 52 is meshed with a plurality of planet gears 54, each of which is carried on a common axle 56 with one of the planet pinion gears 40, which mesh with internal teeth of the torque tube ring gear 34. In embodiments, there are three planet gears 54, three planet axles 56, and three pinion gears 40. As discussed above, the torque tube 20 is supported between the pinion gears 40 and the wheel hub 22. In embodiments, the sun, planet gears, planet pinions, and ring gears provide a high gear ratio from the traction motor 44 to the torque tube 20.

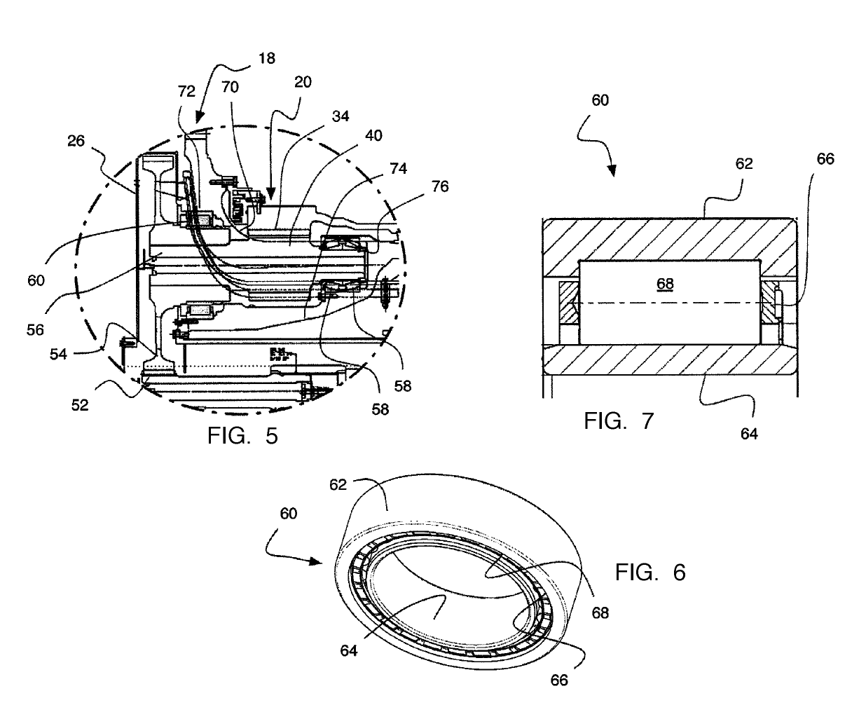

Turning now to FIGS. 5-7, each of the planet axles 56 is supported in the wheel frame 18 by paired thrust bearings 58 and by cylindrical roller bearings 60. Each cylindrical roller bearing 60 is assembled onto one of the planet axles over the attached planet pinion gear 40. In particular, as shown in FIG. 6, in an embodiment of the present invention, each roller bearing 60 includes an outer race 62, an inner race 64, a cage ring 66, and a plurality of rollers 68 captured by the cage ring between the outer race and the inner race. The inner race 64 of each cylindrical roller bearing 60 has an inner diameter sized to pass over the pinion gear 40, while the outer race 62 of each roller bearing has an outer diameter sized to fit within the wheel frame 18 as further discussed below. In some embodiments, dimensional constraints on the cylindrical roller bearing 60 are met by providing an inner race 64 of enlarged inner diameter and reduced inner race thickness. In selected embodiments, the inner race 64 is through hardened to achieve enhanced fatigue strength for its reduced thickness.

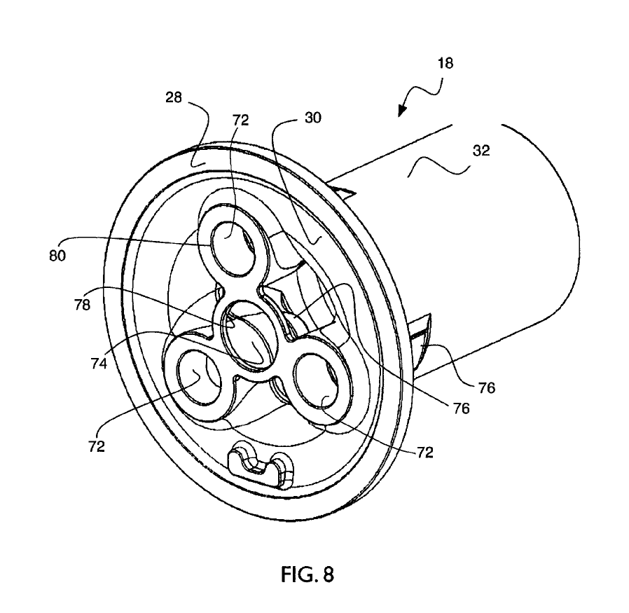

Referring to FIG. 5 and also to FIG. 8, the wheel frame 18 is formed as a unitary or jointless structure, e.g., by a casting process. The transition portion 30 of the wheel frame 18 is formed integrally with the mounting flange 28 and with the barrel portion 32. The transition portion 30 of the wheel frame 18 defines a plurality of planet pinion gear openings or apertures 70 that extend from a radially inward facing surface of the wheel frame 18 to the radially outward facing surface of the transition portion 30. In embodiments, three pinion gear apertures 70 are provided at locations suitable for receiving the pinions 40 of the planetary gear set to be housed within the wheel frame 18. Each pinion gear aperture 70 defines a radial bearing mount 72 for receiving one of the cylindrical roller bearings 60, and includes a radially outwardly concave cupped portion 74 that provides structural rigidity for the radial bearing mount 72 while also providing for engagement of the pinion gear 40 with internal teeth of the ring gear 34 mounted over the wheel frame 18. Adjacent to each pinion gear aperture 70, in axial opposition to and in alignment with the corresponding radial bearing mount 72, a thrust bearing mount 76, for receiving thrust bearings 58, is formed as a significantly thickened portion of the monolithic wheel frame 18. Thus, the radial bearing mounts 72 and the thrust bearing mounts 76 together absorb loads transferred between the wheel frame 18 and each of the planet axles 56.

In embodiments, the thrust bearing mounts 76 is circumferentially spaced rather than being formed as portions of a continuous thickened ring about the wheel frame 18. Alternatively or additionally, the pinion gear apertures 70 and the thrust bearing mounts 76 are symmetrically circumferentially spaced and mutually axially aligned. Alternatively or additionally, edges of the concave cupped portions 74 are joined by a supporting ring 78 that is disposed substantially coplanar with the mounting flange 28. Alternatively or additionally, the supporting ring 78 is in turn joined to the mounting flange 28 by intermediate rings 80 formed by the radial bearing mounts 72.

On account of the mutual arrangement of the roller bearing mounts 72, the concave cupped portions 74, the thrust bearing mounts 76, and the supporting ring 78, loads on the planet axles 56 are transferred such that it is possible for the cylindrical roller radial bearings 60 to have diminished inner race diameter and thickness, and thus reduced overall diameter, relative to previously specified roller bearings for similar designed shaft loadings. Accordingly, it also is possible to package the three planet axles 56 and the associated gearing 40, 54 within a smaller and lighter wheel frame transition portion 30, and mounting flange 28, than previously was possible.

In connection with the present invention, in order to achieve a sufficiently high gear ratio, the planet pinion pitch diameter, and thus the pinion outside diameter, of the pinions 40 within the wheel assembly is increased. In order to fit the roller bearings 60 over the enlarged pinions 40, however, the inner diameter of the inner race of the roller bearings 60 would customarily have to be increased, which, undesirably, translates to increased dimensions of the bearing overall (thus increasing the size and weight of the wheel assembly). Accordingly, embodiments of the present invention provide a cylindrical roller bearing for use with the enlarged pinions 40 wherein all dimensions and load ratings of the roller bearing 60 are maintained, but wherein the inner diameter or the inner race 64 is enlarged, and the cross-sectional thickness of the inner race 64 is reduced, to enable the roller bearing 60 to fit over the enlarged pinions 40.

In an embodiment, the cylindrical roller bearings 60 each have a dynamic load rating of approximately 217,000 lbs (98,636 kg), a static load rating of approximately 389,000 lbs (176,818 kg), and a fatigue load limit of approximately 42,900 lbs (19,500 kg). In an embodiment, with these load ratings, the roller bearing has an inner race 64 having an inner diameter of approximately 228 millimeters and a thickness of approximately 11 millimeters, and an outer race 62 having an inner diameter of approximately 299 millimeters and a thickness of approximately 20.5 millimeters. In an embodiment, the ratio of the thickness of the outer race to the thickness of the inner race is approximately 1.86:1 and the ratio of the inner race diameter to the inner race thickness is approximately 10:1.

Accordingly, the present invention provides a cylindrical roller bearing having an inner race having an enlarged inner diameter and a reduced thickness relative to the radial loads to be supported. In particular, the enlarged inner diameter and reduced thickness of the inner race eliminate the need to utilize a standard roller bearing having an inner race having an increased thickness, and thus increased dimensions and weight overall, to fit over the enlarged pinion 40 of the wheel assembly, which would undesirably translate to increased size and weight of the wheel assembly 16 as a whole.

In use, embodiments of the invention may include a reduced-weight cylindrical roller bearing for supporting radial loads within a wheel drive assembly for use on off-highway vehicles. The cylindrical roller bearing includes an annular outer race, an annular inner race, a plurality of rollers captured between the inner race and the outer race, and a cage operatively connecting together the plurality of rollers for rotating and revolving motion of the rollers between the inner and the outer races. The inner race is of reduced diameter and thickness relative to the radial loads to be supported. In particular, the inner race is of a smaller diameter than expected for use with high-ratio planetary gearing.

In one embodiment, a cylindrical roller bearing is provided. The cylindrical roller bearing includes an annular outer race, an annular inner race, a plurality of rollers captured between the inner race and the outer race and a cage operatively connecting together the plurality of rollers for rotating and revolving motion of the rollers between the inner and the outer races. The inner race has an enlarged inner diameter and a reduced thickness relative to the radial loads to be supported. The inner diameter of the inner race may be approximately 228 millimeters and the thickness of the inner race may be approximately 11 millimeters. The thickness of the outer race may be approximately 20.5 millimeters. Accordingly, the ratio of the thickness of the outer race to the thickness of the inner race may be approximately 1.86:1. In connection with these specifications, the roller bearing may have a dynamic load rating of approximately 217,000 pounds, a static load rating of approximately 389,000 pounds, and a fatigue load limit of approximately 42,900 pounds (98,636 kg, 176,818 kg, and 19,500 kg, respectively).

In another embodiment, a wheel assembly for an off-highway vehicle, includes a wheel frame, a torque tube having a ring gear, a wheel hub secured to the torque tube and supported on the wheel frame and, within the wheel frame, a sun gear shaft splined to a shaft of an electric motor, the sun gear shaft having a sun gear that is meshed with a plurality of planet gears carried on a planet gear shaft, the planet gear shaft having a pinion engaged with the ring gear of the torque tube and being supported in the wheel frame by a plurality of thrust bearings and at least one cylindrical roller bearing. The at least one cylindrical roller bearing has an annular outer race, an annular inner race having a reduced thickness as compared to the outer race and an enlarged inner diameter so as to permit assembly over the pinion of the planet gear shaft, a plurality of rollers captured between the outer race and the inner race and a cage operatively connecting together the plurality of rollers. The wheel assembly may also include a brake assembly axially adjacent to the wheel hub and mounted to the wheel frame. The inner diameter of the inner race may be approximately 228 millimeters and the thickness of the inner race may be approximately 11 millimeters. The thickness of the outer race may be approximately 20.5 millimeters. Accordingly, the ratio of the thickness of the outer race to the thickness of the inner race may be approximately 1.86:1. In connection with these specifications, the roller bearing may have a dynamic load rating of approximately 217,000 pounds, a static load rating of approximately 389,000 pounds, and a fatigue load limit of approximately 42,900 pounds (98,636 kg, 176,818 kg, and 19,500 kg, respectively).

In another embodiment, a cylindrical roller bearing for supporting radial loads within a wheel drive assembly of an off-highway vehicle includes an annular outer race, an annular inner race, a plurality of rollers captured between the inner race and the outer race, and a cage operatively connecting together the plurality of rollers for rotating and revolving motion of the rollers between the inner and the outer races. The inner race has an inner diameter of approximately 228 millimeters and a thickness of approximately 11 millimeters, and the roller bearing has a dynamic load rating of approximately 217,000 pounds (98,636 kg). In addition, the roller bearing may have a static load rating of approximately 389,000 pounds (176,818 kg) and a fatigue load limit of approximately 42,900 pounds (19,500 kg). The inner race of the roller bearing may be through hardened. As used herein, the term “approximately” is defined to mean plus or minus five percent of the given value.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the disclosed subject matter, they are by no means limiting and are exemplary embodiments. Many other embodiments will be apparent to those of ordinary skill in the art upon reviewing the above description. The scope of the inventive subject matter should, therefore, be determined with reference to the appended clauses, along with the full scope of equivalents to which such clauses are entitled. In the appended clauses, the terms “including” and “in which” are used as the plain-English equivalents of the respective terms “comprising” and “wherein.” Moreover, in the following clauses, the terms “first,” “second,” and “third,” etc. are used merely as labels, and are not intended to impose numerical requirements on their objects.

This written description uses examples to disclose several embodiments of the invention, including the best mode, and also to enable any person of ordinary skill in the art to practice the embodiments of invention, including making and using any devices or systems and performing any incorporated methods. The patentable scope of the invention is defined by the clauses, and may include other examples that occur to those ordinarily skilled in the art. Such other examples are intended to be within the scope of the clauses if they have structural elements that do not differ from the literal language of the clauses, or if they include equivalent structural elements with insubstantial differences from the literal languages of the clauses.

The foregoing description of certain embodiments of the present invention will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described cylindrical roller bearing apparatus and method, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A cylindrical roller bearing comprising:
an annular outer race;
an annular inner race;
a plurality of rollers captured between the inner race and the outer race; and
a cage operatively connecting together the plurality of rollers for rotating and revolving motion of the rollers between the inner and the outer races;
wherein the inner race has an enlarged inner diameter and a reduced thickness relative to the radial loads to be supported.

2. The cylindrical roller bearing of claim 1, wherein:
the ratio of the thickness of the outer race to the thickness of the inner race is approximately 1.86:1.

3. The cylindrical roller bearing of claim 1, wherein:
the ratio of the inner race diameter to the inner race thickness is approximately 10.4:1.

4. The cylindrical roller bearing of claim 1, wherein:
the inner diameter of the inner race is approximately 228 millimeters.

5. The cylindrical roller bearing of claim 1, wherein:
the thickness of the inner race is approximately 11 millimeters.

6. The cylindrical roller bearing of claim 5, wherein:
the thickness of the outer race is approximately 20.5 millimeters.

7. The cylindrical roller bearing of claim 1, wherein:
the roller bearing has a dynamic load rating of approximately 98,636 kg.

8. The cylindrical roller bearing of claim 1, wherein:
the roller bearing has a static load rating of approximately 176,818 kg.

9. The cylindrical roller bearing of claim 1, wherein:
the roller bearing has a fatigue load limit of approximately 19,500 kg.

10. A wheel assembly for an off-highway vehicle, comprising:
a wheel frame;
a torque tube having a ring gear;
a wheel hub secured to the torque tube and supported on the wheel frame; and
within the wheel frame, a sun gear shaft splined to a shaft of an electric motor, the sun gear shaft having a sun gear that is meshed with a plurality of planet gears carried on a planet gear shaft, the planet gear shaft having a pinion engaged with the ring gear of the torque tube and being supported in the wheel frame by a plurality of thrust bearings and at least one cylindrical roller bearing;
wherein the at least one cylindrical roller bearing has an annular outer race, an annular inner race having a reduced thickness as compared to the outer race and an enlarged inner diameter so as to permit assembly over the pinion of the planet gear shaft, a plurality of rollers captured between the outer race and the inner race, and a cage operatively connecting together the plurality of rollers.

11. The wheel assembly of claim 10, wherein:
the ratio of the thickness of the outer race to the thickness of the inner race is approximately 1.86:1.

12. The wheel assembly of claim 10, wherein:
the inner diameter of the inner race is approximately 228 millimeters.

13. The wheel assembly of claim 12, wherein:
the thickness of the inner race is approximately 11 millimeters.

14. The wheel assembly of claim 10, further comprising:
a brake assembly axially adjacent to the wheel hub and mounted to the wheel frame.

15. The wheel assembly of claim 10, wherein:
the roller bearing has a dynamic load rating of approximately 98,636 kg.

16. The wheel assembly of claim 10, wherein:
the roller bearing has a static load rating of approximately 176,818 kg.

17. The wheel assembly of claim 10, wherein:
the roller bearing has a fatigue load limit of approximately 19,500 kg.

18. A cylindrical roller bearing for supporting radial loads within a wheel drive assembly of an off-highway vehicle, the bearing comprising:
an annular outer race;
an annular inner race;
a plurality of rollers captured between the inner race and the outer race; and
a cage operatively connecting together the plurality of rollers for rotating and revolving motion of the rollers between the inner and the outer races;
wherein the inner race has an inner diameter of approximately 228 millimeters and a thickness of approximately 11 millimeters; and
wherein the roller bearing has a dynamic load rating of approximately 98,636 kg.

19. The cylindrical roller bearing of claim 18, wherein:
the roller bearing has a static load rating of approximately 176,818 kg.

20. The cylindrical roller bearing of claim 18, wherein:
the roller bearing has a fatigue load limit of approximately 19,500 kg.

21. The cylindrical roller bearing of claim 18, wherein:
the inner race is through hardened.
